(19) United States
(12) Patent Application Publication
(10) Pub. No.: US 2022/0002100 A1
(43) Pub. Date: Jan. 6, 2022

(54) PAPER INPUT MODULE FOR A PRINTING APPARATUS

(71) Applicant: Canon Production Printing Holding B.V., Venlo (NL)

(72) Inventors: Erik P.J. VERHOEVEN, Venlo (NL); Henricus J.A. VAN DE SANDE, Venlo (NL); Luc LINDERS, Venlo (NL); Pim DU BUF, Venlo (NL)

(73) Assignee: Canon Production Printing Holding B.V., Venlo (NL)

(21) Appl. No.: 17/358,782

(22) Filed: Jun. 25, 2021

(30) Foreign Application Priority Data
Jul. 2, 2020 (EP) 20183744.0

(51) Int. Cl. B65H 3/12; B41J 13/08

(52) U.S. Cl. CPC B65H 3/128; B41J 13/08

(57) ABSTRACT

A paper input module for use in a printing apparatus includes a substantially closed box for holding a stack of sheets of a print substrate; a duct in fluid connection with the closed box and arranged for transporting a sheet of the print substrate out of the paper input module; and a transport mechanism for engaging a sheet of the print substrate to exit the paper input module via the duct. A method for conditioning a stack of print substrates in such a paper input module is also disclosed.

### FIELD OF THE INVENTION

The present invention relates to a paper input module (paper tray) for use in a printing apparatus.

### BACKGROUND ART

It is known in the art that printing material, in particular paper, can become wavy and deform as a result of the action of changing temperatures and, in particular, high atmospheric humidity. This may cause paper blockages in the printing machine and impairs the printed result. This problem occurs, in particular in the paper store (also known as paper input module or paper input tray), since here paper sheets (sheets of print substrate) are stored for a relatively long time outside their packaging. In published US patent application 2002/0131805, a substantially airtight paper store for a printing machine is disclosed for solving or at least mitigating this problem. Such paper input modules generally have a slit through which a sheet of a print substrate (e.g. a sheet of printing paper) exits the paper store for being entered into printing apparatus. The slit may be equipped with a lid covering the slit, which lid automatically opens for letting a sheet of print substrate pass.

It is desirable that a stack of sheets of print substrate is conditioned, in particular relating to moist, the relative humidity may not be too high in the vicinity of the stack of sheets of print substrate to prevent excessive moist take up by the printing substrate which may hence cause deformation of the print substrates before, during or after printing.

It is further disclosed in said published US patent application to actively condition the interior space of the paper store by controlling the relative humidity in the vicinity of the stack of sheets of printing substrate in the paper store. A skilled person knows how to actively control the relative humidity in the interior space of the paper input module, e.g. by measuring the relative humidity (and temperature) using sensors arranged inside the paper input module and to control the relative humidity by adding water vapor to the interior space of the paper input module to increase the relative humidity and to refresh the air inside the interior space of the paper input module to decrease the relative humidity.

It is a disadvantage of the known implementation that the lid covering the exit slit of the paper input module, or alternative embodiments like an elongated flap covering the exit slit, comprise moving parts which may optionally be actively controlled to open and close. Such parts are prone to defects and risk causing paper jams. Another disadvantage is that in such embodiments the speed of exiting sheets of print substrate is limited by the capability to open an close the slit and if during printing the slit is permanently opened enabling high speed printing, the airtightness of the paper input module is seriously impaired, which may increase the risk of print substrate deformation again.

### SUMMARY OF THE INVENTION

It is therefore an object of the present invention to solve or at least mitigate above disadvantages.

This object can be achieved by elimination of moving parts, while maintaining the prevention of excessive loss of conditioned air from the interior of the paper input module. Inventors have surprisingly found that this object is achieved by providing a narrow air duct in fluid connection to the paper input module, through which duct sheets of print substrate can be exited from the paper input module (paper store) without the necessity to close the exit slit.

In a first aspect, the invention pertains to a paper input module for use in a printing apparatus comprising:
a substantially closed box for holding a stack of sheets of a print substrate;
a duct in fluid connection with the closed box and arranged for transporting a sheet of the print substrate out of the paper input module;
a transport mechanism for engaging a sheet of the print substrate to exit the paper input module via the duct;
   characterized in that the duct has a width, w; a length, l and a height, h; wherein the width is accommodated to a width of the sheet of the print substrate and wherein an aspect ratio of the duct is defined as the length divided by the height (AR=l/h) wherein the aspect ratio is larger than 2, preferably larger than 4.

The duct comprised in the paper input module according to the present invention comprises an entry sided which is in fluid connection with the closed box and an exit side which is open to the ambient environment and can be connected to an entry side of a printing machine. The duct is dimensioned such that ambient (outside the module) air influx is prevented or at least substantially mitigated such that the conditions (temperature and relative humidity) can be easily maintained in the interior space of the paper input module, without the need of intermediate (i.e. between sheets) closure of the exit of the paper input module.

In an embodiment, the aspect ratio (AR) is between 5 and 20, preferably between 10 and 15

In an embodiment the length of the duct l is at least 3 cm, preferably at least 8 cm, more preferably at least 15 cm.

In an embodiment, the height of the duct h is at most 1 cm, preferably at most 0.8 cm, more preferably at most 0.5 cm.

In an embodiment the substantially closed box comprises a mechanism for installing a stack of sheets of print substrate in the interior space of the paper input module, for example a drawer or a door.

In an embodiment the paper input comprises a seal for creating an airtight connection between the substantially closed box and the mechanism for installing a stack of sheets of print substrate in the interior space of the paper input module.

In an embodiment, the seal comprises a rubber strip.

In an embodiment, the transport mechanism for engaging a sheet of the print substrate to exit the paper input module via the duct comprises a sheet separation mechanism, e.g. air assisted sheet separation mechanism and a transport mechanism engaging with the sheet of print substrate after being separated from the stack.

In another aspect the invention pertains to a method for conditioning a stack of print substrates in a paper input module according to the first aspect of the invention, the method comprising the steps of:
providing a packaged stack of sheets of a print substrate;
unpacking the packaged stack of sheets of print substrate and immediately installing the unpacked stack in the interior space of the paper input module;
closing the paper input module;
equilibrating the interior space of the paper input module with the stack of sheets of a print substrate.

### BRIEF DESCRIPTION OF THE DRAWINGS

For a more complete understanding of the invention and the advantages thereof, exemplary embodiments of the invention are explained in more detail in the following description with reference to the accompanying drawing FIGURE, in which like reference characters designate like parts and in which:

FIG. 1 shows a schematic representation of a paper input module according to the present invention.

### DETAILED DESCRIPTION

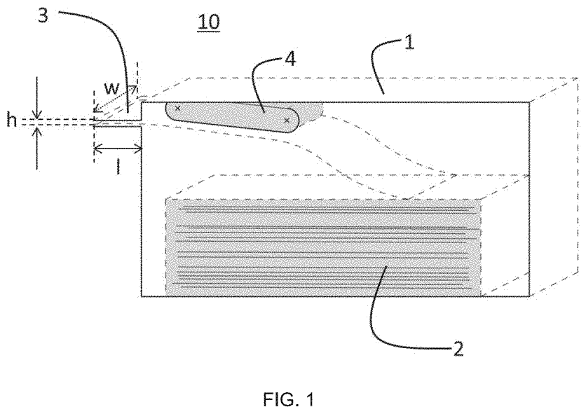

FIG. 1 shows a schematic representation of a paper input module according to the present invention. The paper input module 10 comprises a substantially closed box 1 for holding a stack of sheets of a print substrate 2, a duct 3 in fluid connection with the closed box and arranged for transporting a sheet of the print substrate out of the paper input module, the duct having a width w, a length l an a height h; wherein the width is accommodated to a width of the sheet of the print substrate and wherein an aspect ratio of the duct is defined as the length divided by the height (AR=l/h).

FIG. 1 further shows a transport mechanism 4 for engaging a sheet of the print substrate to exit the paper input module via the duct. Separation of a single sheet from the stack can be realized in any known way including with air-based sheet separation with internal recirculation of air in order to prevent or at least mitigate convection through the slit (not shown).

Without wanting to be bound to any theory, a duct according to the present invention prevents diffusion of moisture from the ambient environment (in the context of the present invention ambient environment means environment outside the substantially closed box of the paper input module, e.g. located at no. 10 in FIG. 1) into the paper input module. Increasing the length of the duct further restricts the moisture influx due to diffusion. Further, convection through the slit should be insignificant and if any, the flow should be laminar. To obtain this the height of the slit must be small.

In use, the paper input module according to the present invention enables to isolate a stack of sheets of print substrate from the ambient environment. In equilibration the environment in the interior of the paper input module adjusts to the properties of the stack of sheets. In this way, the climate in the interior of the paper input module is set by the stack of sheet of print substrate itself. Each (different) print substrate type sets its own climate. A print operator does not have to set a set point for relative humidity per used print substrate type.

The paper input module according to the present invention does not require an additional conditioning unit, meaning no humidifier, no active relative humidity control. The serviceability of the paper input module improves a lot.

Another advantage of the paper input module according to the present invention is that the paper input module can be switched off when the print engine is turned off. In a switched off mode of the paper input module the convection through the duct is reduced to zero. The paper input module is substantially airtight; hence the equilibrated conditions in the interior space of the paper input module hardly change.

1. A paper input module for use in a printing apparatus comprising:
a substantially closed box for holding a stack of sheets of a print substrate;
a duct in fluid connection with the closed box and arranged for transporting a sheet of the print substrate out of the paper input module; and
a transport mechanism for engaging a sheet of the print substrate to exit the paper input module via the duct,
wherein the duct has a width, w, a length, l and a height, h, and
wherein the width is accommodated to a width of the sheet of the print substrate, wherein an aspect ratio of the duct is defined as the length divided by the height (AR=l/h), and wherein the aspect ratio is larger than 2.

2. The paper input module according to claim 1, wherein the aspect ratio (AR) is between 5 and 20.

3. The paper input module according to claim 1, wherein the length of the duct l is at least 3 cm.

4. The paper input module according to claim 2, wherein the length of the duct l is at least 3 cm.

5. The paper input module according to claim 1, wherein the height of the duct h is at most 1 cm.

6. The paper input module according to claim 2, wherein the height of the duct h is at most 1 cm.

7. The paper input module according to claim 3, wherein the height of the duct h is at most 1 cm.

8. The paper input module according to claim 1, wherein the substantially closed box comprises a mechanism for installing a stack of sheets of print substrate in the interior space of the paper input module.

9. The paper input module according to claim 8, wherein the paper input comprises a seal for creating an airtight connection between the substantially closed box and the mechanism for installing a stack of sheets of print substrate in the interior space of the paper input module.

10. The paper input module according to claim 9, wherein the seal comprises a rubber strip.

11. A method for conditioning a stack of print substrates in a paper input module according to claim 1, the method comprising the steps of:
providing a packaged stack of sheets of a print substrate;
unpacking the packaged stack of sheets of print substrate and immediately installing the unpacked stack in the interior space of the paper input module;
closing the paper input module; and
equilibrating the interior space of the paper input module with the stack of sheets of a print substrate.
